(19) United States
(12) Patent Application Publication
(10) Pub. No.: US 2015/0160912 A1
(43) Pub. Date: Jun. 11, 2015

(54) METHOD AND ELECTRONIC DEVICE FOR PROCESSING INFORMATION

(71) Applicants: Beijing Lenovo Software Ltd., Beijing (CN); Lenovo (Beijing) Limited, Beijing (CN)

(72) Inventors: Weiwei Zhang, Beijing (CN); Ge Gao, Beijing (CN)

(21) Appl. No.: 14/462,060

(22) Filed: Aug. 18, 2014

(30) Foreign Application Priority Data
Dec. 11, 2013 (CN) 201310676911.1

(51) Int. Cl. G06F 3/14; G09G 5/12; G09G 5/00

(52) U.S. Cl. CPC G06F 3/1454; G09G 5/003; G09G 5/12; G09G 2370/20; G09G 2354/00; G09G 2340/14

(57) ABSTRACT

The present disclosure discloses a method and an electronic device for processing information to address the technical problem that the electronic device cannot be used for the user to view the data information because the display screen of the electronic device is blocked or occupied due to demands of operating an electronic device. The method comprises: establishing a communication connection to a second electronic device via the communication unit; acquiring a first trigger operation indicating to turn on the first projection unit;turning on the first projection unit in response to the first trigger operation during the communication between the first electronic device and the second electronic device; and projecting to obtain a first projection display interface in a projection area of the first projection unit, wherein the first projection display interface is formed in the projection area when the projection area is present on a first bearing plane.

### CROSS-REFERENCE TO RELATED APPLICATION(S)

This application claims priority to the Chinese Application No. 201310676911.1, filed on Dec. 11, 2013, which is incorporated herein by reference in its entirety.

### TECHNICAL FIELD

The present disclosure relates to the field of electronic technology, and in particular, to a method and an electronic device for processing information.

### BACKGROUND

With rapid development of the electronic technology, various kinds of electronic devices, such as, smart phones, tablets, notebook computers, etc., come into people's lives. These electronic devices have increasingly richer functional applications and bring a great deal of convenience into people's daily lives.

Nowadays, more electronic devices have display screens for users to perform human-machine interaction therewith such that it is more straightforward and convenient for the users to operate data in the electronic devices.

However, at least following technical problems are found by the inventors of the present disclosure during the implementations of technical solutions according to the embodiments of the present disclosure.

Sometimes, due to demands of operating an electronic device, the display screen may be blocked or occupied such that the user may not view the data in the electronic device. For example, when a user uses a mobile phone to perform voice communication and does not use an earphone, or when the user uses the mobile phone to perform video communication, the user cannot view the information in the mobile phone while the current communication is maintained. Therefore, there is a technical problem that the electronic device cannot be used for the user to view the data information because the display screen of the electronic device is blocked or occupied due to demands of operating an electronic device.

### SUMMARY

According to embodiments of the present disclosure, a method and an electronic device for processing information are provided to address the technical problem that the electronic device cannot be used for the user to view the data information because the display screen of the electronic device is blocked or occupied due to demands of operating an electronic device. The technical effect that the electronic device may be used for the user to view data information even if the display screen is blocked or occupied during the user operation of the electronic device can be achieved.

On one hand, an embodiment of the present disclosure provides a method for processing information, the method being applied in a first electronic device comprising a first projection unit and a communication unit, the method comprising:

establishing a communication connection to a second electronic device via the communication unit;

acquiring a first trigger operation indicating to turn on the first projection unit during the communication between the first electronic device and the second electronic device;

turning on the first projection unit in response to the first trigger operation; and

projecting to obtain a first projection display interface in a projection area of the first projection unit, wherein the first projection display interface is formed in the projection area when the projection area is present on a first bearing plane.

Optionally, the first electronic device further comprises a collecting unit and the collecting unit has a corresponding collecting area which coincides with the projection area, and after the projecting to obtain the first projection display interface, the method further comprises:

acquiring an input operation of an operating body on the first projection display interface through the collecting area; and

controlling data in the first electronic device corresponding to the input operation and displaying on the first projection display interface in response to the input operation.

Optionally, the second electronic device comprises a second projection unit, and before the acquiring of an input operation of an operating body on the first projection display interface through the collecting area, the method further comprises:

generating synchronization information by the first electronic device such that the second electronic device turns on the second projection unit to project and display a second projection display interface, the second projection display interface displaying the same content as the first projection display interface.

Optionally, the controlling data in the first electronic device corresponding to the input operation and displaying on the first projection display interface in response to the input operation comprises:

controlling data in the first electronic device corresponding to the input operation and acquiring an operation track of the input operation in response to the input operation;

displaying the operation track on the first projection display interface projected and displayed by the first projection unit; and

transmitting the operation track to the second electronic device concurrently, such that the second electronic device is able to display the operation track via the second projection display interface projected and displayed by the second projection unit.

Optionally, the controlling data in the first electronic device corresponding to the input operation and displaying on the first projection display interface in response to the input operation comprises:

controlling data in the first electronic device corresponding to the input operation and displaying the data on the first projection display interface projected and displayed by the first projection unit in response to the input operation;

transmitting the data to the second electronic device concurrently, such that the second electronic device is able to display the data via the second projection display interface projected and displayed by the second projection unit.

Optionally, the communication connection comprises: a voice communication connection and a video communication connection.

Optionally, the first electronic device comprises a projection optical path switching unit connected to the first projection unit, and the first projection display interface is projected to the projection area through the projection optical path switching unit, the acquiring of the first trigger operation comprises:

acquiring the first trigger operation for controlling the projection optical path switching unit when the communication connection is a video communication connection.

On the other hand, an embodiment of the present disclosure further provides an electronic device for processing information, the electronic device comprising:

a first connecting unit configured to establish a communication connection to a second electronic device via a communication unit of the electronic device;

a first acquiring unit configured to acquire a first trigger operation indicating to turn on a first projection unit of the electronic device during the communication between the electronic device and the second electronic device;

a first turning-on unit configured to turn on the first projection unit in response to the first trigger operation; and

a second acquiring unit configured to project to obtain a first projection display interface in a projection area of the first projection unit, wherein the first projection display interface is formed in the projection area when the projection area is present on a first bearing plane.

Optionally, the electronic device further comprises:

a third acquiring unit configured to, when the electronic device comprises a collecting unit and the collecting unit has a corresponding collecting area which coincides with the projection area, and after the second acquiring unit projects to obtain the first projection display interface, acquire an input operation of an operating body on the first projection display interface through the collecting area; and

a first response unit configured to control data in the first electronic device corresponding to the input operation and to display on the first projection display interface in response to the input operation.

Optionally, the electronic device further comprises:

a first generating unit configured to, when the second electronic device comprises a second projection unit, and before the third acquiring unit acquires an input operation of an operating body on the first projection display interface through the collecting area, generate synchronization information by the electronic device such that the second electronic device turns on the second projection unit to project and display a second projection display interface, the second projection display interface displaying the same content as the first projection display interface.

Optionally, the first response unit comprises:

a first acquiring sub-unit configured to control data in the electronic device corresponding to the input operation and to acquire an operation track of the input operation in response to the input operation;

a first display sub-unit configured to display the operation track on the first projection display interface projected and displayed by the first projection unit; and

a first transmission sub-unit configured to, transmit the operation track to the second electronic device concurrently with the first display sub-unit displaying the operation track on the first projection display interface projected and displayed by the first projection unit, such that the second electronic device is able to display the operation track via the second projection display interface projected and displayed by the second projection unit.

Optionally, the first response unit comprises:

a second display sub-unit configured to control data in the electronic device corresponding to the input operation and to display the data on the first projection display interface projected and displayed by the first projection unit in response to the input operation;

a second transmission sub-unit configured to transmit the data to the second electronic device concurrently with the second display sub-unit controlling data in the electronic device corresponding to the input operation and displaying the data on the first projection display interface projected and displayed by the first projection unit in response to the input operation, such that the second electronic device is able to display the data via the second projection display interface projected and displayed by the second projection unit.

Optionally, the communication connection comprises: a voice communication connection and a video communication connection.

Optionally, the first acquiring unit comprises:

a second acquiring sub-unit configured to acquire the first trigger operation for controlling the projection optical path switching unit when the electronic device comprises a projection optical path switching unit connected to the first projection unit, the first projection display interface is projected in the projection area through the projection optical path switching unit, and the communication connection is a video communication connection.

One or more technical solutions provided in the embodiments of the present disclosure have at least following technical effects.

(1) In an embodiment of the present disclosure, during the communication between the first electronic device and the second electronic device, the first electronic device may acquire the first trigger operation, turn on the first projection unit, and project to obtain the first projection display interface in the projection area of the first projection unit. In other words, during the communication between the first electronic device and the second electronic device, the first electronic device may turn on the projection unit to project a projection interface, according to the operation instruction issued by the user, for the user to view data information, so as to address the technical problem that the electronic device cannot be used for the user to view the data information because the display screen of the electronic device is blocked or occupied due to demands of operating an electronic device. The technical effect that the electronic device may be used for the user to view data information even if the display screen is blocked or occupied during the user operation of the electronic device can be achieved.

(2) In an embodiment of the present disclosure, the first electronic device comprises a collecting unit which collects the input operation of the user on the first projection display interface, and the data in the first electronic device may be operated according to the input operation and displayed on the first projection interface at the same time. The technical effect that the projection interface of the electronic device may be operated by the user can be achieved.

(3) In an embodiment of the present disclosure, when the second electronic device also comprises a projection unit, the first electronic device may generate synchronization information such that the second electronic device turns on the second projection unit to project and display the second projection display interface through the second projection unit. In other words, the first electronic device and the second electronic device may project the same projection display interface. In this way, the following technical effect may be achieved: the data information may be shared in real-time, through the same projection display interface, among multiple electronic devices in communication with each other, and the shared data information may be viewed by multiple users in real-time.

(4) In an embodiment of the present disclosure, the first electronic device may transmit the operation track of the user on the first projection display interface projected by the first projection unit to the second electronic device, and the same operation track may be displayed on the second projection display interface projected by the second projection unit of the second electronic device. In this way, the following technical effect can be achieved: the operation track may be shared by users, through the same projection display interface, among the multiple electronic devices in communication with each other, and when sharing users view the operation track, the sharing users may be aware of the specific operation actions of a sharing user through the operation track.

(5) In an embodiment of the present disclosure, the communication between the first electronic device and the second electronic device may be voice communication or video communication. In other words, during the voice communication or video communication, multiple electronic devices may share the data information through the same projection interface projected by respective electronic devices, and the shared data information may be viewed by multiple users.

(6) In an embodiment of the present disclosure, when the video communication is conducted between the first electronic device and the second electronic device, the first electronic device may acquire the trigger operation to the projection optical path switching unit and turn on the first projection unit through the trigger operation to project to obtain the first projection display interface. In this way, the technical effect that the projection unit and the projection display interface may be turned on rapidly such that the data sharing may be performed rapidly can be achieved.

### BRIEF DESCRIPTION OF THE DRAWINGS

FIG. 1 is a flow chart illustrating a method for processing information according to an embodiment of the present disclosure;

FIGS. 2A-2B are schematic diagrams showing the position of a projection unit according to an embodiment of the present disclosure;

FIGS. 3A-3B are schematic diagrams showing the position of a projection optical path switching unit according to an embodiment of the present disclosure;

FIGS. 4A-4B are schematic diagrams of various projection manners according to embodiments of the present disclosure; and

FIG. 5 is a block diagram of the structure of an electronic device according to an embodiment of the present disclosure.

### DETAILED DESCRIPTION

An embodiment of the present disclosure provides a method and an electronic device for processing information to address the technical problem that the electronic device cannot be used for the user to view the data information because the display screen of the electronic device is blocked or occupied due to demands of operating an electronic device. The technical effect that the electronic device may be used for the user to view data information even if the display screen is blocked or occupied during the user operation of the electronic device can be achieved.

In order to address the above problem, the technical solution of embodiments of the present disclosure has following general ideas.

A method for processing information is provided, the method being applied in a first electronic device comprising a first projection unit and a communication unit, the method comprising: establishing a communication connection to a second electronic device via the communication unit; acquiring a first trigger operation indicating to turn on the first projection unit during the communication between the first electronic device and the second electronic device; turning on the first projection unit in response to the first trigger operation; and projecting to obtain a first projection display interface in a projection area of the first projection unit, wherein the first projection display interface is formed in the projection area when the projection area is present on a first bearing plane.

Based thereon, in an embodiment of the present disclosure, during the communication between the first electronic device and the second electronic device, the first electronic device may acquire the first trigger operation, turn on the first projection unit, and project to obtain the first projection display interface in the projection area of the first projection unit. In other words, during the communication between the first electronic device and the second electronic device, the first electronic device may turn on the projection unit to project a projection interface, according to the operation instruction issued by the user, for the user to view data information, so as to address the technical problem that the electronic device cannot be used for the user to view the data information because the display screen of the electronic device is blocked or occupied due to demands of operating an electronic device. The technical effect that the electronic device may be used for the user to view data information even if the display screen is blocked or occupied during the user operation of the electronic device can be achieved.

In order to understand the above technical solution better, the above technical solutions will be described in detail with reference to the drawings and specific implementations. It is to be understood that the embodiments of the present disclosure and the specific features in the embodiments are only detailed explanation of the technical solutions of the present disclosure, rather than limitations to the technical solutions of the present disclosure. The embodiments of the present disclosure and the technical features of the embodiments may be combined with each other without any conflict.

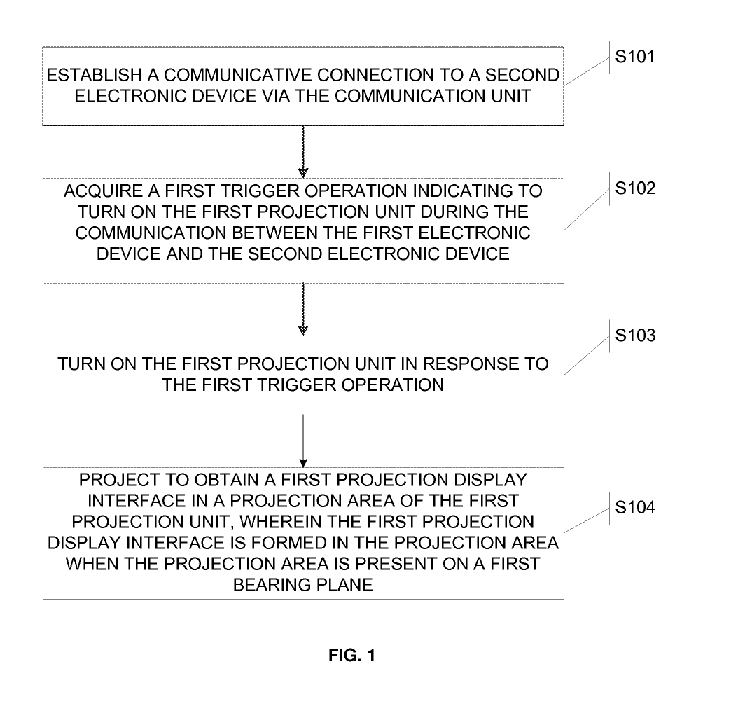

Referring to FIG. 1, an embodiment of the present disclosure provides a method for processing information. The method is applied in a first electronic device, such as, a smart phone, a notebook computer, a tablet, etc. The first electronic device comprises a first projection unit and a communication unit. The method may comprise steps of:

S101: a communication connection to a second electronic device is established via the communication unit, wherein the second electronic device may also be a smart phone, a notebook computer, a tablet, etc.;

S102: a first trigger operation (such as, a voice trigger or a hardware trigger operation, etc.) indicating to turn on the first projection unit is acquired during the communication between the first electronic device and the second electronic device;

S103: the first projection unit is turned on in response to the first trigger operation; and

S104: projection is performed to obtain a first projection display interface in a projection area of the first projection unit, wherein the first projection display interface is formed in the projection area when the projection area is present on a first bearing plane.

In a specific implementation, in order to enable the projection interface of the electronic device to be operated by the user, the first electronic device further comprises a collecting unit and the collecting unit has a corresponding collecting area which coincides with the projection area, and after the projection is performed to obtain the first projection display interface, the method further comprises:

acquiring an input operation of an operating body on the first projection display interface through the collecting area;

controlling data in the first electronic device corresponding to the input operation and displaying on the first projection display interface in response to the input operation.

In particular, in order to enable multiple electronic devices in communication with each other to share data information in real-time through the same projection display interface, and to enable multiple users to view the shared data information in real-time, the second electronic device may also comprise a second projection unit, and before an input operation of an operating body on the first projection display interface is acquired through the collecting area, the method further comprises:

generating synchronization information by the first electronic device such that the second electronic device turns on the second projection unit to project and display a second projection display interface, the second projection display interface displaying the same content as the first projection display interface.

Further, in order to enable multiple electronic devices in communication with each other to share an operation track through the same projection display interface, and to enable the sharing users to be aware of a sharing user's specific operation actions through the operation track when the operation track is viewed, the controlling of data in the first electronic device corresponding to the input operation and displaying on the first projection display interface in response to the input operation may comprise:

controlling data in the first electronic device corresponding to the input operation and acquiring an operation track of the input operation in response to the input operation;

displaying the operation track on the first projection display interface projected and displayed by the first projection unit; and

transmitting the operation track to the second electronic device concurrently, such that the second electronic device is able to display the operation track via the second projection display interface projected and displayed by the second projection unit.

Furthermore, the controlling of data in the first electronic device corresponding to the input operation and displaying on the first projection display interface in response to the input operation may comprise:

controlling data in the first electronic device corresponding to the input operation, and displaying the data on the first projection display interface projected and displayed by the first projection unit in response to the input operation; and

transmitting the data to the second electronic device concurrently, such that the second electronic device is able to display the data via the second projection display interface projected and displayed by the second projection unit.

In a specific implementation, the communication connection may comprise a voice communication connection and a video communication connection, such that when multiple electronic devices are in voice communication or video communication, the same projection interface may be projected via respective electronic devices, and data information may be shared to be viewed by multiple users.

Further, in order to turn on the projection unit and the projection display interface rapidly to allow rapid data sharing, the first electronic device comprises a projection optical path switching unit connected to the first projection unit, and the first projection display interface is projected in the projection area through the projection optical path switching unit, the acquiring of the first trigger operation may comprise:

acquiring the first trigger operation for controlling the projection optical path switching unit when the communication connection is a video communication connection.

In a specific implementation, the communication connection between the first electronic device and the second electronic device may be a voice communication connection or a video communication connection. In Embodiment 1 of the present disclosure, a situation where both electronic devices only support projection during voice communication will be introduced below. In Embodiment 2 of the present disclosure, a situation where both electronic devices only support projection during video communication will be introduced. In Embodiment 3 of the present disclosure, a situation where both electronic devices support both projection during voice communication and projection during video communication will be introduced.

### Embodiment 1

In an embodiment of the present disclosure, an example where both of a first electronic device and a second electronic device are smart phones and perform voice communication will be described. A user A of the first electronic device (i.e. the mobile phone A) and a user B of the second electronic device (i.e. the mobile phone B) are performing voice communication through these two mobile phones. A voice detection unit in the mobile phone A is enabled, and the voice detection unit may use sensitive words, such as, “let's . . . together”, “let me show you . . . ”, etc. as the trigger operations to turn on a first projection unit of the mobile phone A, wherein the sensitive words may be set as required and no specific limitation is imposed thereon. In particular, during the conversation between the user A and the user B, the user A may suddenly want to show one picture in his/her own mobile phone (i.e., the mobile phone A) to the user B, and then the user A may say “let me show you a picture”. At this time, the voice detection unit of the mobile phone A detects the sensitive words “let me show you . . . ”, and then turns on the first projection unit of the mobile phone A. In addition to the first projection unit being turned on by voice, the first projection unit may be turned on by hardware-based trigger operations. In other words, the mobile phone A may have a hardware button on its body. When the user A wants to share information in the mobile phone A with the user B, the user A may trigger the hardware button by hand to turn on the first projection unit. After that, the user A may see a first projection display interface projected by the first projection unit, and find the data information in the mobile phone A to be shared with the user B through the operations on the first projection display interface.

The mobile phone A may be used by the user A to find, through the operations on the first projection interface, the data information in the mobile phone A to be shared because the mobile phone A comprises a collecting unit which in particular may be a gesture detecting unit. The collecting unit has a corresponding collecting area. As long as the user A performs a gesture input operation in this collecting area, the gesture detecting unit may collect the specific operations of the user A by infrared and control the data of the mobile phone A to respond according to this input operation. For example, the user A clicks on a shortcut to “My Pictures” displayed on the first projection display interface. The gesture detecting unit detects this action, opens the folder corresponding to this shortcut, and displays the pictures in the folder on the first projection display interface for the user to choose.

Of course, the input operations collected by the collecting unit may not necessarily come from the user A, but may come from others. In other words, the electronic device will respond as long as there is an operating body performing input operations in the collecting area. Of course, in other embodiments, the collecting unit may also be other detecting unit, such as, a camera detecting unit.

Further, in order to enable the mobile phone B, which is in voice communication with the mobile phone A, to display the shared picture displayed on the first projection display interface and to enable the user B to see the picture shared by the user A, the mobile phone B comprises a second projection unit, and the mobile phone A will generate synchronization information and transmit it to the mobile phone B, such that the second projection unit of the mobile phone B is enabled to project and display the shared picture. In this embodiment, the mobile phone A generates and transmits the synchronization information to the mobile phone B while the shared picture is found. In other embodiments, the mobile phone A may generate and transmit the synchronization information to the mobile phone B when the first trigger operation is acquired to turn on the first projection unit.

Further, in this embodiment, the mobile phone A may also transmit the operation track of the input operation of the user A (or other operating bodies) to the mobile phone B for the first projection interface projected by the second projection unit to display the operation track. For example, when the user A and the user B are in voice communication, the user A wants to tell the user B the highlight of the shared picture. When the user A performs a Zoom-In operation at the highlight of the shared picture displayed on the first projection display interface projected by the first projection unit, the user B may view the Zoom-In operation performed at the highlight of the shared picture by virtual fingers on the second projection display interface projected by the second projection unit, wherein the Zoom-In operation performed on the shared picture by the virtual fingers is same as that on the shared picture by the user A. For another example, the topic of the conversation between the user A and the user B may relate to going someplace together (for example, an amusement park). The user A shares a map page with the user B, and the user A wants to tell the user B where he/she is and a specific path to the destination. When the user A marks on the map page displayed by the first projection display interface projected by the first projection unit, the user B may simultaneously view the marks made by the user A on the map page displayed on the second projection display interface projected by the second projection unit. In particular, the mobile phone B may also comprise a collecting unit which is able to collect the input operation of the user B. In other words, the user B may also mark his/her own location and a specific path to the destination on the map page displayed by the second projection display interface projected by the second projection unit, and transmit to the mobile phone A concurrently such that the user A may also view the marks made by the user B on the first projection display interface projected by the first projection unit.

In this embodiment, the collecting area of the collecting unit coincides with the projection area of the first projection unit, and the operating body can be recognized by the mobile phone A only when the input operation is performed in the collecting area. In a specific implementation, a user performs voice communication by pressing a surface of a mobile phone, on which the display unit is present, against to his/her ear. When the user holds the mobile phone by his/her left hand with the above posture to perform the voice communication, in order to ensure the collecting area of the electronic device to collect the input operation of the users, the projection unit of the electronic device should be set on the right side 201 of the electronic device or the bottom end surface 202. Similarly, when the user holds the mobile phone by his/her right hand with the above posture to perform a voice communication, the projection unit should be set on the left side 203 of the mobile phone or the bottom end surface 202, such that the projection display interface is projected by the projection unit on the wall surface in front of the users, on the user's hand, or on the ground to display the projection display interface.

### Embodiment 2

In an embodiment of the present disclosure, an example where both of a first electronic device and a second electronic device are still smart phones will be described. When the user A of the first electronic device (i.e., a mobile phone A) and the user B of the second electronic device (i.e., a mobile phone B) perform video communication through the two mobile phones. Usually, the mobile phone will display the image of the other user via the display screen. At this time, the display screen of the mobile phone A is occupied by the image of the other user (i.e., the user B), and the user A can only use the first projection display interface projected by the first projection unit of the mobile phone A to display the data information of the mobile phone A. In this embodiment, the specific implementation in which the mobile phone A acquires the trigger operation to turn on the first projection unit, the implementation in which the collecting unit of the mobile phone A collects the input operation of the operating body, and the implementation in which the mobile phone A and the mobile phone B generate and transmit synchronization information are same as or similar to those in Embodiment 1, and will be omitted for simplicity.

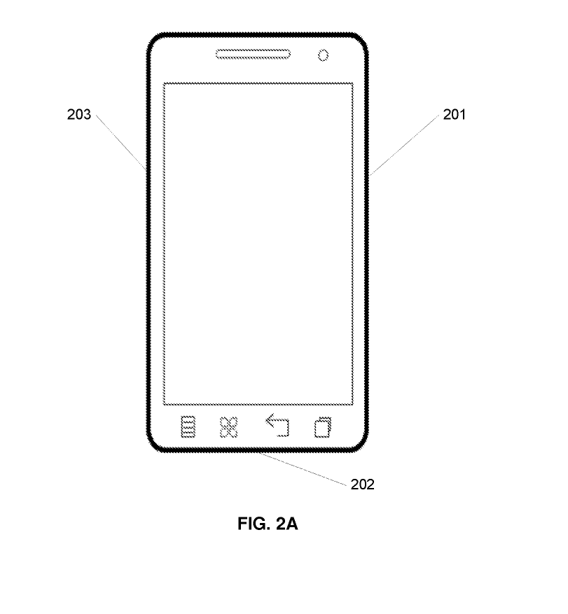

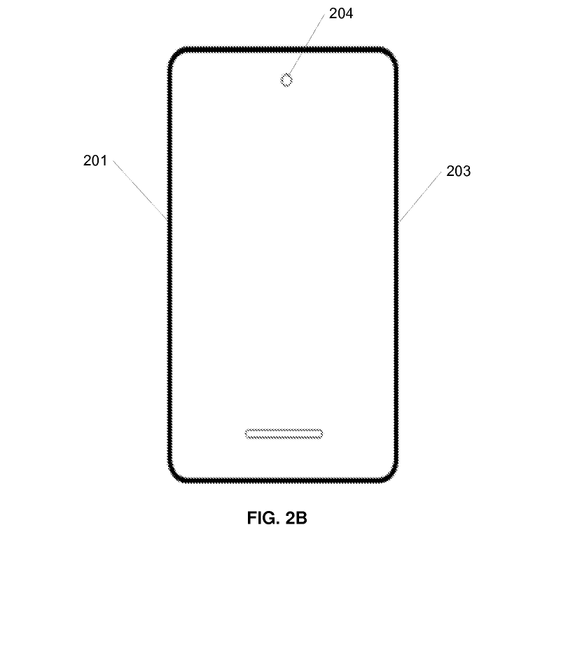

In an embodiment of the present disclosure, when the user uses the display screen of the electronic device as the display interface for the images of the other user, the user A will usually place the mobile phone A in a standing position on a horizontal bearing plane, such as, a desktop surface, such that the display screen of the mobile phone A is substantially parallel to the face of the user A. Only in this way, it can be ensured that the user A may view the images of the other user clearly. Referring to FIG. 2B, at this time, the first projection unit of the mobile phone A may be set on the left side 203, the right side 201, and the back 204 of the mobile phone A. In other words, the first projection display interface is projected and displayed on the walls on both left and right sides of the user A, or on the wall opposite to the back of the mobile phone A. The user A may perform input operations on the walls on both left and right sides or on the wall opposite to the back of the mobile phone A.

### Embodiment 3

In this embodiment, all implementations recited in Embodiment 1 and Embodiment 2 are involved. The difference is in that: in this embodiment, not only the projection function during voice communication is supported, but also the projection function during video communication is supported. Therefore, the projection unit of the electronic device should be set on the left side and also the right side of the electronic device.

By means of the above Embodiment 2 and Embodiment 3, it can be found in practice that when the first projection unit is set on both left and right sides of the mobile phone A, the first projection display interface will be displayed on the walls on both left and right side of the user, respectively. When the user A performs the sharing operation, he/she needs to perform the input operations towards to the walls on both left and right sides, such that the user A cannot face the mobile phone A to perform a fluent video communication with the user B. Further, when the first projection unit is set on the back of the mobile phone A, though the first projection display interface thus projected is opposite to the user A, the mobile phone A would block partial collection area, resulting in inconvenience to operation of the user A.

In other words, in Embodiment 2 and Embodiment 3, though the manner in which the projection unit is set during video communication may be feasible to some extent, it is not optimal. In Embodiment 4 of the present disclosure, a manner in which the projection unit is set will be provided in conjunction with the method for processing information according to embodiments of the present disclosure, such that the projection display interface projected by the electronic device during video communication may be used to facilitate the user in performing input operations on the projection display interface without interfering the normal video communication among the users.

### Embodiment 4

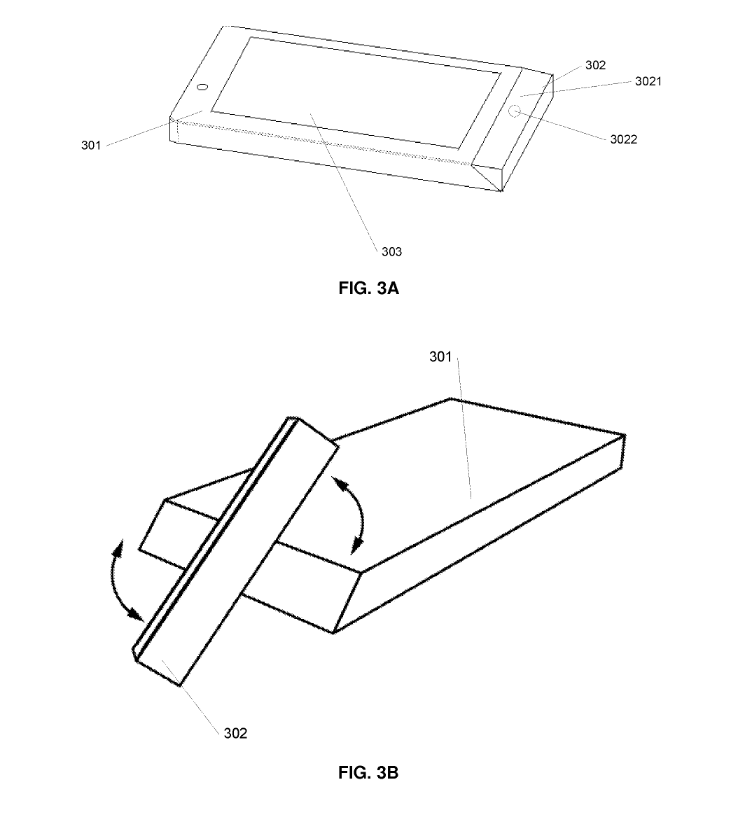

In this embodiment, the first electronic device comprises a projection optical path switching unit connected to the first projection unit, and the first projection display interface is projected to the projection area, in particular, through the projection optical path switching unit. Referring to FIG. 3A, the first electronic device comprises a first body 301 and a projection optical path switching unit 302 rotatably connected to the first body 301, wherein a display unit 303 is set on the first body 301 and the first projection unit is set inside of the first body 301.

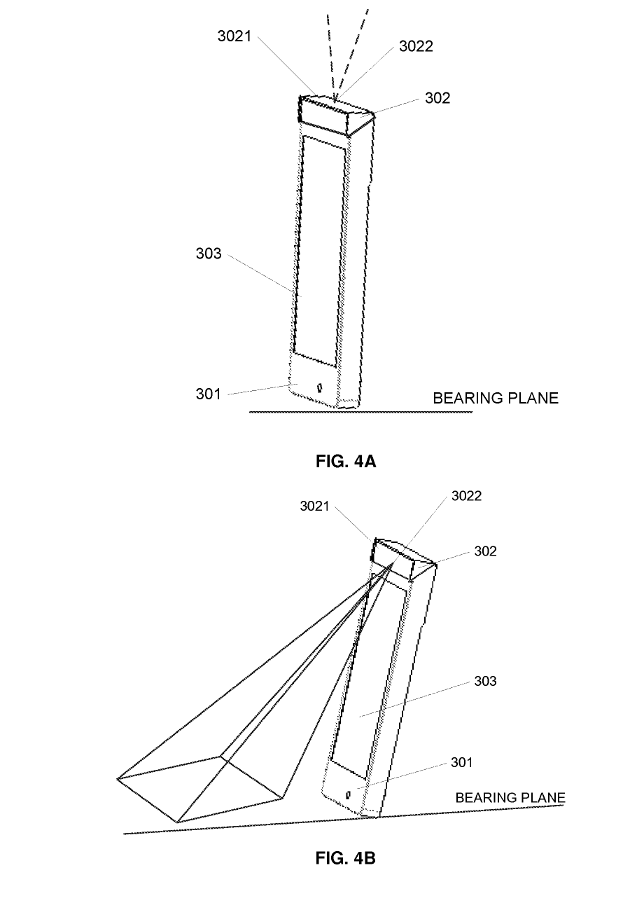

The first plane 3021 of the projection optical path switching unit comprises a light outlet 3022, and the projection display interface of the projection unit is projected from the light outlet 3022 to the external. Referring to FIG. 4A, when the projection optical path switching unit 302 has a first relative position with respect to the first body 301, the first plane 3021 of the projection optical path switching unit 302 that has the light outlet 3022 faces upwards. Still referring to FIG. 3A, when the projection optical path switching unit 302 has a second relative position with respect to the first body 301, the first plane 3021 of the projection optical path switching unit 302 that has the light outlet 3022 lies in the same plane with the display unit 303 of the first body 301.

An example where the first electronic device and the second electronic device still are smart phones will be described. When the user A of the first electronic device (i.e., the mobile phone A) and the user B of the second electronic device (i.e., the mobile phone B) perform video communication through these two mobile phones, and when the user A wants to share information with the user B, referring to FIG. 3B, the user A may rotate the optical path switching unit of the first electronic device to turn on the first projection unit and perform the projection in a manner as shown in FIG. 4B. In other words, the projection optical path switching unit 302 has the second relative position with respect to the first body 301. At this time, the first electronic device stands on a bearing surface (such as, the desktop surface), and the display unit of the first electronic device displays the images of the user B. The first projection display interface projected by the first projection unit is projected to the bearing interface in front of the display screen by the projection optical path switching unit, to facilitate the user A in performing input operations on the first projection display interface during the video communication with the user B.

In the scenario of the above implementation, a bearing plane (such as, the desktop surface) for placing the electronic device and facilitating the user in viewing the display screen is required. However, during walking, it is inconvenient for the user A to perform video communication with the user B. At this time, the user A may rotate the projection optical path switching unit back to the original state, i.e., the state where the projection optical path switching unit has the first relative position with respect to the first body, and the first electronic device is switched from the video communication to the voice communication.

Likewise, when the user A of the first electronic device (i.e., the mobile phone A) and the user B of the second electronic device (i.e., the mobile phone B) perform voice communication through these two mobile phones and the user A wants to switch the voice communication to the video communication with the user B, the first electronic device first turns on the first projection unit in a way illustrated in Embodiment 1. At this time, the first projection display interface is projected upwards as shown in FIG. 3B. The user may rotate the projection optical path switching unit from the first relative position to the second relative position with respect to the first body. The manner in which the communication is performed between these two electronic devices is thus switched from the voice communication to the video communication.

In summary, in this embodiment, the relative position of the projection optical path switching unit with respect to the first body may be changed by rotating the projection optical path switching unit, so as to achieve the switching of the electronic device between the voice communication and the video communication.

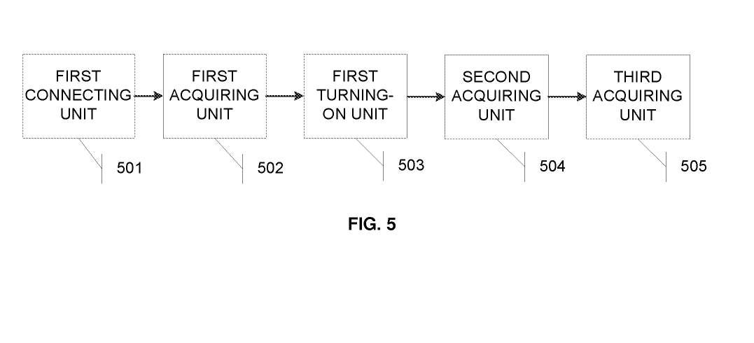

On the other hand, referring to FIG. 5, an embodiment of the present disclosure further provides an electronic device for processing information, the electronic device comprising:

a first connecting unit 501 configured to establish a communication connection to a second electronic device via a communication unit of the electronic device;

a first acquiring unit 502 configured to acquire a first trigger operation indicating to turn on a first projection unit of the electronic device during the communication between the electronic device and the second electronic device;

a first turning-on unit 503 configured to turn on the first projection unit in response to the first trigger operation; and

a second acquiring unit 504 configured to project to obtain a first projection display interface in a projection area of the first projection unit, wherein the first projection display interface is formed in the projection area when the projection area is present on a first bearing plane.

In a specific implementation, in order to enable the projection interface of the electronic device to be operated by the users, the first electronic device further comprises a collecting unit and the collecting unit has a corresponding collecting area which coincides with the projection area. The electronic device further comprises:

a third acquiring unit 505 configured to, when the electronic device comprises a collecting unit and the collecting unit has a corresponding collecting area which coincides with the projection area, and after the second acquiring unit 504 projects to obtain the first projection display interface, acquire an input operation of an operating body on the first projection display interface through the collecting area; and

a first response unit configured to control data in the first electronic device corresponding to the input operation and to display on the first projection display interface in response to the input operation.

In particular, in order to enable multiple electronic devices in communication with each other to share data information in real-time through the same projection display interface, and to enable multiple users to view the shared data information in real-time, the electronic device further comprises:

a first generating unit configured to, when the second electronic device comprises a second projection unit, and before the third acquiring unit 505 acquires an input operation of an operating body on the first projection display interface through the collecting area, generate synchronization information by the electronic device such that the second electronic device turns on the second projection unit to project and display a second projection display interface, the second projection display interface displaying the same content as the first projection display interface.

Further, in order to enable multiple electronic devices in communication with each other to share operation tracks through the same projection display interface, and to enable the shared user to view the specific operating actions of the sharing users through the operation tracks when the operation tracks are viewed, the first response unit may comprise:

a first acquiring sub-unit configured to control data in the electronic device corresponding to the input operation and to acquire an operation track of the input operation in response to the input operation;

a first display sub-unit configured to display the operation track on the first projection display interface projected and displayed by the first projection unit; and

a first transmission sub-unit configured to, transmit the operation track to the second electronic device concurrently with the first display sub-unit displaying the operation track on the first projection display interface projected and displayed by the first projection unit, such that the second electronic device is able to display the operation track via the second projection display interface projected and displayed by the second projection unit.

Further, the first response unit may comprise:

a second display sub-unit configured to control data in the electronic device corresponding to the input operation and to display the data on the first projection display interface projected and displayed by the first projection unit in response to the input operation; and

a second transmission sub-unit configured to transmit the data to the second electronic device concurrently with the second display sub-unit controlling data in the electronic device corresponding to the input operation and displaying the data on the first projection display interface projected and displayed by the first projection unit in response to the input operation, such that the second electronic device is able to display the data via the second projection display interface projected and displayed by the second projection unit.

In a specific implementation, in order to enable multiple electronic devices in a voice communication or a video communication to share data information via the same projection interface projected by respective electronic devices, and to enable multiple users to view the data information, the communication connection may comprise a voice communication connection and a video communication connection.

Further, in order to turn on the projection unit and the projection display interface rapidly, the first acquiring unit 502 may comprise:

a second acquiring sub-unit configured to acquire the first trigger operation for controlling the projection optical path switching unit when the electronic device comprises a projection optical path switching unit connected to the first projection unit, and the first projection display interface is projected in the projection area through the projection optical path switching unit, and when the communication connection is a video communication connection.

One or more technical solutions provided in the embodiments of the present disclosure have at least following technical effects.

(1) In an embodiment of the present disclosure, during the communication between the first electronic device and the second electronic device, the first electronic device may acquire the first trigger operation, turn on the first projection unit, and project to obtain the first projection display interface in the projection area of the first projection unit. In other words, during the communication between the first electronic device and the second electronic device, the first electronic device may turn on the projection unit to project a projection interface, according to the operation instruction issued by the user, for the user to view data information, so as to address the technical problem that the electronic device cannot be used for the user to view the data information because the display screen of the electronic device is blocked or occupied due to demands of operating an electronic device. The technical effect that the electronic device may be used for the user to view data information even if the display screen is blocked or occupied during the user operation of the electronic device can be achieved.

(2) In an embodiment of the present disclosure, the first electronic device comprises a collecting unit which collects the input operation of the user on the first projection display interface, and the data in the first electronic device may be operated according to the input operation and displayed on the first projection interface concurrently. The technical effect that the projection interface of the electronic device may be operated by the user can be achieved.

(3) In an embodiment of the present disclosure, when the second electronic device also comprises a projection unit, the first electronic device may generate synchronization information such that the second electronic device turns on the second projection unit to project and display the second projection display interface through the second projection unit. In other words, the first electronic device and the second electronic device may project the same projection display interface. In this way, the following technical effect may be achieved: the data information may be shared in real-time, through the same projection display interface, among multiple electronic devices in communication with each other, and the shared data information may be viewed by multiple users in real-time.

(4) In an embodiment of the present disclosure, the first electronic device may transmits the operation track of the user on the first projection display interface projected by the first projection unit to the second electronic device concurrently, and display the same operation track on the second projection display interface projected by the second projection unit of the second electronic device. In this way, the following technical effect can be achieved: the operation track may be shared by users, through the same projection display interface, among the multiple electronic devices in communication with each other, and when the sharing users view the operation track, the sharing users may be aware of the specific operating actions of a sharing user through the operation track.

(5) In an embodiment of the present disclosure, the communication between the first electronic device and the second electronic device may be voice communication or video communication. In other words, during the voice communication or video communication, multiple electronic devices may share the data information through the same projection interface projected by respective electronic devices, and the shared data information may be viewed by multiple users.

(6) In an embodiment of the present disclosure, when the video communication is conducted between the first electronic device and the second electronic device, the first electronic device may acquire the trigger operation to the projection optical path switching unit and turn on the first projection unit through the trigger operation to project to obtain the first projection display interface. In this way, the technical effect that the projection unit and the projection display interface may be turned on rapidly such that the data sharing may be performed rapidly can be achieved.

It should be appreciated by one skilled in the art that the embodiments of the present disclosure may be provided as methods, systems, or computer program products. Therefore, the present disclosure may be implemented in pure hardware, pure software, or the combination of software and hardware. Further, the present disclosure may be implemented as a computer program product embodied on one or more computer usable storage media (comprising but not limited to disk storage, CD-ROM, optical storage, etc.) having computer usable program code therein.

The present disclosure is described with reference to flow charts and/or block diagrams of the methods, devices (systems), and computer program products according to embodiments of the present disclosure. It is to be understood that any flow and/or block in the flow charts and/or block diagrams and any combination of flow and/or block in the flow charts and/or block diagrams may be implemented by computer program instructions. These computer program instructions may be provided to processors of general purpose computers, special purpose computers, embedded processing machines or any other programmable data processing devices to form a machine such that means having functions specified in one or more flows in the flow charts and/or one or more blocks in the block diagrams can be implemented by instructions executed by processors of the computers or any other programmable data processing devices.

The computer program instructions may also be stored in computer readable memories which may guide the computers or any other programmable data processing devices to function in such a manner that the instructions stored in these computer readable memories may generate products comprising instruction means, the instruction means implementing functions specified in one or more flows in the flow charts and/or one or more blocks in the block diagrams.

These computer program instructions may also be loaded to computers or any other programmable data processing devices such that a series of operation steps are performed on the computers or any other programmable devices to generate processing implemented by the computers. Therefore, the instructions executed on the computers or any other programmable devices provide steps for implementing functions specified in one or more flows in the flow charts and/or one or more blocks in the block diagrams.

In particular, the computer program instructions corresponding to the method for processing information according to embodiments of the present disclosure may be stored on a storage medium, such as, an optical disc, a hard drive, a U-disk. When the computer program instructions in the storage medium corresponding to this method for processing information is loaded or executed by an electronic device, it performs steps of:

establishing a communication connection to a second electronic device via the communication unit;

acquiring a first trigger operation indicating to turn on the first projection unit during the communication between the first electronic device and the second electronic device;

turning on the first projection unit in response to the first trigger operation; and

projecting to obtain a first projection display interface in a projection area of the first projection unit, wherein the first projection display interface is formed in the projection area when the projection area is present on a first bearing plane.

Optionally, the first electronic device further comprises a collecting unit and the collecting unit has a corresponding collecting area which coincides with the projection area, and after the projecting to obtain the first projection display interface, the method corresponding to the executed computer instructions stored in the storage medium further comprises:

acquiring an input operation of an operating body on the first projection display interface through the collecting area;

controlling data in the first electronic device corresponding to the input operation and displaying on the first projection display interface in response to the input operation.

Optionally, the second electronic device comprises a second projection unit, and the storage medium further stores some other computer instructions. These computer instructions are executed before the acquiring of an input operation of an operating body on the first projection display interface through the collecting area, and when these computer instructions are executed, the method further comprises:

generating synchronization information by the first electronic device such that the second electronic device turns on the second projection unit to project and display the first projection display interface.

Optionally, the computer instructions stored in the storage medium corresponding to the controlling data in the first electronic device corresponding to the input operation and displaying on the first projection display interface in response to the input operation, when executed, comprises:

controlling data in the first electronic device corresponding to the input operation and acquiring an operation track of the input operation in response to the input operation;

displaying the operation track on the first projection display interface projected and displayed by the first projection unit; and

transmitting the operation track to the second electronic device concurrently, such that the second electronic device is able to display the operation track via the second projection display interface projected and displayed by the second projection unit.

Optionally, the computer instructions stored in the storage medium corresponding to the controlling data in the first electronic device corresponding to the input operation and displaying on the first projection display interface in response to the input operation, when executed, comprises:

controlling data in the first electronic device corresponding to the input operation and displaying the data on the first projection display interface projected and displayed by the first projection unit in response to the input operation; and

transmitting the data to the second electronic device concurrently, such that the second electronic device is able to display the data via the second projection display interface projected and displayed by the second projection unit.

Optionally, the communication connection may comprise a voice communication connection and a video communication connection.

Optionally, the first electronic device comprises a projection optical path switching unit connected to the first projection unit, and the first projection display interface is projected in the projection area through the projection optical path switching unit, the computer instructions stored in the storage medium corresponding to the acquiring of the first trigger operation, when executed, comprises:

acquiring the first trigger operation for controlling the projection optical path switching unit when the communication connection is a video communication connection.

Although preferred embodiments of the present disclosure have been described, further alterations and modifications may be made to these embodiments once one skilled in the art is aware of the underlying inventive concepts. Therefore, the attached claims are intended to cover the preferred embodiments and all alterations and modifications falling into the scope of the present disclosure.

It is obvious that one skilled in the art may make various modifications and variants to the present disclosure without departing from the spirit and scope of the present disclosure. In this way, if these modifications and variants of the present disclosure belong to the scope of the claims of the present disclosure and its full scope equivalents, the present disclosure is intended to embrace these modifications and variants.

I/We claim:

1. A method for processing information, the method being applied in a first electronic device comprising a first projection unit and a communication unit, the method comprising:
establishing a communication connection to a second electronic device via the communication unit;
acquiring a first trigger operation indicating to turn on the first projection unit during the communication between the first electronic device and the second electronic device;
turning on the first projection unit in response to the first trigger operation; and
projecting to obtain a first projection display interface in a projection area of the first projection unit, wherein the first projection display interface is formed in the projection area when the projection area is present on a first bearing plane.

2. The method according to claim 1, wherein the first electronic device further comprises a collecting unit and the collecting unit has a corresponding collecting area which coincides with the projection area, and after the projecting to obtain the first projection display interface, the method further comprises:
acquiring an input operation of an operating body on the first projection display interface through the collecting area; and
controlling data in the first electronic device corresponding to the input operation and displaying on the first projection display interface in response to the input operation.

3. The method according to claim 2, wherein the second electronic device comprises a second projection unit, and before the acquiring of an input operation of an operating body on the first projection display interface through the collecting area, the method further comprises:
generating synchronization information by the first electronic device such that the second electronic device turns on the second projection unit to project and display a second projection display interface, the second projection display interface displaying the same content as the first projection display interface.

4. The method according to claim 3, wherein the controlling data in the first electronic device corresponding to the input operation and displaying on the first projection display interface in response to the input operation comprises:
controlling data in the first electronic device corresponding to the input operation and acquiring an operation track of the input operation in response to the input operation;
displaying the operation track on the first projection display interface projected and displayed by the first projection unit; and
transmitting the operation track to the second electronic device concurrently, such that the second electronic device is able to display the operation track via the second projection display interface projected and displayed by the second projection unit.

5. The method according to claim 3, wherein the controlling data in the first electronic device corresponding to the input operation and displaying on the first projection display interface in response to the input operation comprises:
controlling data in the first electronic device corresponding to the input operation and displaying the data on the first projection display interface projected and displayed by the first projection unit in response to the input operation; and
transmitting the data to the second electronic device concurrently, such that the second electronic device is able to display the data via the second projection display interface projected and displayed by the second projection unit.

6. The method according to claim 1, wherein the communication connection comprises a voice communication connection and a video communication connection.

7. The method according to claim 6, wherein the first electronic device comprises a projection optical path switching unit connected to the first projection unit, and the first projection display interface is projected in the projection area through the projection optical path switching unit, and wherein the acquiring of the first trigger operation comprises:
acquiring the first trigger operation for controlling the projection optical path switching unit when the communication connection is a video communication connection.

8. An electronic device, comprising:
a first connecting unit configured to establish a communication connection to a second electronic device via a communication unit of the electronic device;
a first acquiring unit configured to acquire a first trigger operation indicating to turn on a first projection unit of the electronic device during the communication between the electronic device and the second electronic device;
a first turning-on unit configured to turn on the first projection unit in response to the first trigger operation; and
a second acquiring unit configured to project to obtain a first projection display interface in a projection area of the first projection unit, wherein the first projection display interface is formed in the projection area when the projection area is present on a first bearing plane.

9. The electronic device according to claim 8, wherein the electronic device further comprises:
a third acquiring unit configured to, when the electronic device comprises a collecting unit and the collecting unit has a corresponding collecting area which coincides with the projection area, and after the second acquiring unit projects to obtain the first projection display interface, acquire an input operation of an operating body on the first projection display interface through the collecting area; and
a first response unit configured to control data in the first electronic device corresponding to the input operation and to display on the first projection display interface in response to the input operation.

10. The electronic device according to claim 9, wherein the electronic device further comprises:
a first generating unit configured to, when the second electronic device comprises a second projection unit and before the third acquiring unit acquires an input operation of an operating body on the first projection display interface through the collecting area, generate synchronization information by the electronic device such that the second electronic device turns on the second projection unit to project and display a second projection display interface, the second projection display interface displaying the same content as the first projection display interface.

11. The electronic device according to claim 10, wherein the first response unit comprises:
a first acquiring sub-unit configured to control data in the electronic device corresponding to the input operation and to acquire an operation track of the input operation in response to the input operation;
a first display sub-unit configured to display the operation track on the first projection display interface projected and displayed by the first projection unit; and
a first transmission sub-unit configured to, transmit the operation track to the second electronic device concurrently with the first display sub-unit displaying the operation track on the first projection display interface projected and displayed by the first projection unit, such that the second electronic device is able to display the operation track via the second projection display interface projected and displayed by the second projection unit.

12. The electronic device according to claim 10, wherein the first response unit comprises:
a second display sub-unit configured to control data in the electronic device corresponding to the input operation and to display the data on the first projection display interface projected and displayed by the first projection unit in response to the input operation; and
a second transmission sub-unit configured to transmit the data to the second electronic device concurrently with the second display sub-unit controlling data in the electronic device corresponding to the input operation and displaying the data on the first projection display interface projected and displayed by the first projection unit in response to the input operation, such that the second electronic device is able to display the data via the second projection display interface projected and displayed by the second projection unit.

13. The electronic device according to claim 8, wherein the communication connection comprises a voice communication connection and a video communication connection.

14. The electronic device according to claim 13, wherein the first acquiring unit comprises:
a second acquiring sub-unit configured to, when the electronic device comprises a projection optical path switching unit connected to the first projection unit, and the first projection display interface is projected to the projection area through the projection optical path switching unit, and when the communication connection is a video communication connection, acquire the first trigger operation for controlling the projection optical path switching unit.
